(19) United States
(12) Patent Application Publication
(10) Pub. No.: US 2004/0245228 A1
(43) Pub. Date: Dec. 9, 2004

(54) Attach aligned optics and microelectronics with laser soldering methods

(76) Inventors: Hongwei Liu, San Jose, CA (US); John E. Sell, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/455,115

(22) Filed: Jun. 4, 2003

(51) Int. Cl. B23K 1/005

(52) U.S. Cl. 219/121.85; 219/121.76

(57) ABSTRACT

Fluxless laser soldering methods are used to securely bond an optical or microelectronic component to a substrate. A component is aligned on a substrate. The substrate comprises solder dams in joint areas and solder is placed in the joint areas between the dams and the component. Oxygen is evacuated from the joint areas such as by a vacuum or by filling the area with a gas. Lasers may be fired simultaneously or sequentially at the solder in each of the joint areas to reflow the solder. When the solder re-solidifies a strong bond is created securing the component to the substrate.

### FIELD OF THE INVENTION

An embodiment of the present invention relates to fluxless soldering and, more particularly to fluxless laser soldering techniques.

### BACKGROUND INFORMATION

One of the major challenges in the optoelectronic assembly process is to couple light from one chip to another chip or waveguide while maintaining tight tolerances. In brief, the alignment process can generally be summarized in just a couple of steps.

First, the two components are aligned. Tight tolerances are required. For example, tolerances of less than 50 nm of precision are not uncommon between the components. Second, the components must be bonded or otherwise secured to a surface while being careful to keep the alignment. Finally, the assembly needs to be reliable. That is, the finished assembly including the bonding must be stable under temperature cycling, aging, shock, vibration, and any other condition that the assembly may reasonably be expected to encounter.

There are essentially three conventional techniques for attaching optical or electrical components to a substrate. These include epoxy bonding, global soldering, and laser welding. Epoxy bonding involves using a chemical epoxy or “glue” to join two parts. Conventional or “global” soldering involves using a solder which is reflowed (melted) to bond two parts after re-solidification. Both epoxy bonding and conventional soldering techniques generally require the whole component to be heated. This is often not possible as such temperatures may damage temperature sensitive portions of the underlying components.

More recently, laser welding has become a viable alternative attaching components which does not require global heating or solder. In this case a pinpointed laser beam heats two metals at a spot and causes the metals to fuse together creating a very strong bond. The laser energy absorption by a material is affected by several factors including the type of laser, the incident power density, and the base metal's surface condition and reflectivity. However, there are several drawbacks to laser welding including the high cost of laser welding equipment as well as a relatively high degree of post bonding shift of the two components joined.

### BRIEF DESCRIPTION OF THE DRAWINGS

FIG. 1 is a schematic of a laser soldering setup according to one embodiment of the invention;

FIG. 2 is a schematic of a laser soldering setup which shows laser soldering for a narrow component; and

FIG. 3 is a schematic of a laser soldering setup which shows laser soldering for a wider component.

### DETAILED DESCRIPTION

Unlike laser welding which involves spot heating two metals to be joined to the point of fusion, laser soldering involves using a laser beam to reflow a solder. Laser soldering has been used to make electrical connections such as attaching electrical leads to a substrate. In this case, a flux is used and later cleaned off to insure a good electrical contact. However the underlying component is typically attached using epoxy, laser welding, or by global soldering as previously described.

Solders are special composition metals (known as alloys) that, when in the presence of flux, melt at relatively low temperatures (120-450° C.), and wet the surrounding materials. The most commonly used solders contain tin and lead as base components. Many alloy variations exist that include two or more of the following metallic elements: tin (Sn), lead (Pb), silver (Ag), bismuth (Bi), antimony (Sb) and copper (Cu). Solder works by melting when it is heated, and bonding (wetting) to metallic surfaces. The solder forms a permanent intermetallic bond between the metals joined, essentially acting like a metal “glue.” In addition to providing a bonding function, solder joints also provide an electrical connection between soldered components and a heat transfer path. Solders are available in many forms including paste, wire, bar, ribbon, preforms and ingots.

Generally, metal surfaces have a thin film of oxidation or passivation caused by normal environmental exposure to air and oxygen that acts as a barrier during the soldering process. Accordingly, a chemical product (usually rosin-based) known as “flux” is used to prepare the metal surfaces for soldering by cleaning off oxides, passivation and other contamination. Flux also reduces the surface tension of the solder alloy to promote wetting out over exposed solderable surfaces beyond the initial deposit location. During the preheating stage, the flux is working and the alloy is approaching its melting point. After the solder becomes completely molten, heat is removed to allow re-solidification of the alloy in its new position.

There are four basic flux types to choose from that provide a wide variety of capabilities. No-Clean (NC) flux consists of rosin, solvent, and a small amount of activator. NC flux has low activity and is suited to easily solderable surfaces. NC residue is clear, hard, non-corrosive, non-conductive, and designed to be left on the assembly. Residue may be removed with an appropriate solvent if so desired. Rosin Mildly Activated (RMA) flux consists of rosin, solvent, and a small amount of activator. Most RMA flux is fairly low in activity and best suited to easily solderable surfaces. RMA flux residue is clear, soft, non-corrosive, and non-conductive. Cleaning is optional. Residue may be removed with an appropriate solvent if desired. Rosin activated (RA) flux consists of rosin, solvent, and aggressive activators. RA flux has higher activity than RMA for moderately oxidized surfaces. RA flux residue is corrosive and should be removed as soon as possible after reflow to prevent damage to the assembly. Maximum safe time before cleaning is product dependent. Residue may be removed with an appropriate solvent. Water Soluble (WS) flux consists of organic acids, thixotrope, and solvent. WS flux comes in a range of activity levels for soldering to even the most difficult surfaces. WS flux residue is corrosive and should be removed as soon as possible after reflow to avoid damage to the assembly. The maximum safe time before cleaning is generally product dependent. Typically, residue may be removed with 60° C. (140° F.) water and 40 psi pressure.

A problem with the foregoing conventional soldering approaches is that the use of flux is intolerable under some manufacturing processes. For example, all fluxes, including even NC and RMA fluxes, leave residues containing contaminants that are unsuitable for manufacturing certain types of semiconductor-based assemblies and optical communication equipment. These situations call for the use of fluxless solder assembly techniques.

Embodiments of the present invention are directed to using a laser soldering technique to actually make the bond to secure an opto-electrical component to a substrate or workpiece. This invention includes the use of a high power light beam, for example, diode laser beam, to melt solder and make solder bonding in a local areas in a very short period of time. It is a fluxless process that only needs to heat up local component and substrate areas to solder melting temperature for reflow. Good attachment of components may be realized without the need to heat up the entire component or the substrates as is the case with epoxy and conventional soldering techniques. In addition, since solder generally melts at a much lower temperature than is required for welding techniques relatively inexpensive laser equipment may be employed.

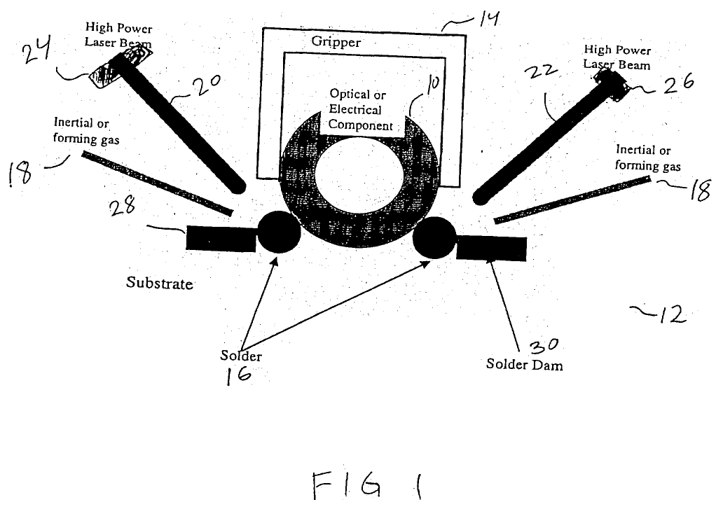

Referring to FIG. 1, there is shown an illustrative set up for using laser soldering to attach and optical or electrical component 10 to a substrate 12. The component 10 is passively or actively aligned to the substrate using for example a gripper tool 14. The gripper 14 is simply a tool for maneuvering the component into position and may be hand held or part of a more complex robotic arm in the case of an automated system. While the gripper 14 is still holding the component 10, solder 16 is placed between the substrate 12 and the component 10 at the bonding point. The solder 16 may be in any one of several forms including a solder ball, a solder perform, or a solder wire.

In order to address the problem of oxidation which may degrade the bond, the actual reflow process may take place in an evacuated environment or in the presence of an inert gas 18 such as nitrogen, argon, helium or any combination thereof. A forming gas comprising hydrogen and nitrogen or a formic gas comprising water vapor, nitrogen, and an acid may also be used. Under these techniques, the oxidation problem is substantially reduced or eliminated by removing oxygen from the environment. In this example, since two bonding locations are shown, two high powered light beams 20 and 22, such as from laser diodes 24 and 26 fire simultaneously to cause the solder 16 to reflow (melt). Solder dams 28 and 30 may be placed on the substrate 12 between the component 10 and the solder 16 to prevent the molten solder 16 from flowing out of the joint.

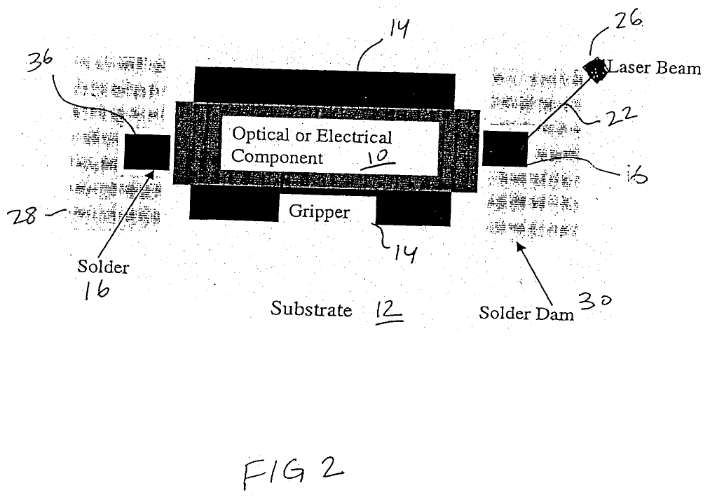

In the above example, two lasers are fired simultaneously. However, for certain applications, such as when bonding smaller or narrower components as shown in FIG. 2, only one laser 26 firing one beam 22 may be used. In this case, if a second laser solder joint is to be made, such as at point 36, either the laser 26 may be repositioned and aimed at the joint 36 or the entire substrate and may be maneuvered under the laser 26 which is then fired a second time.

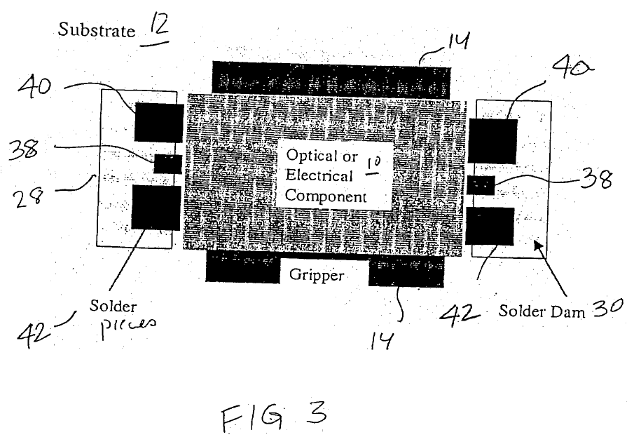

FIG. 3 shows an example laser soldering set up for a wider component 10. In this case, it may be beneficial to first tack the component in place with small solder pieces 38 to help maintain alignment of the component 10. The tack solder 38 may be reflowed with the laser near the center of he component 10 as shown to minimize any movement that may occur when solder joints 40 and 42 are made to firmly secure the component 10 to the substrate 12. Thereafter, additional laser firings may follow to make stronger solder joints at points 40 and 42. The laser solder joints may be made sequentially such as joint 40 and then joint 42 if one laser is used or both joints 40 and 42 may be made simultaneously if two lasers are used.

The following table compares the various bonding approaches to that of laser soldering according to embodiments of the present invention.

| | Epoxy | Conventional | Laser | Laser |
|---|---|---|---|---|
| | Bonding | Soldering | Welding | Soldering |
| Post-bonding | Medium | High | High | Low |
| shift | | | | |
| Equipment | Low | Medium | Very high | Medium |
| cost | | | | |
| Heating | Global | Global | Local | Local |
| Cleanness | Outgassing | Flux | Clean | Clean |
| | and bleeding | | | |
| Flexibility | Yes | Not really | No | Yes |
| Bonding | Low | High | Very high | High |
| strength | | | | |

As is shown in the table, laser soldering has relatively low post bonding shift as compared to other bonding methods, does not require expensive equipment, uses local heating, is clean (fluxless), offers a high degree of flexibility, as well as provides a high bonding strength. Thus, embodiments may be used in many optical or electrical applications where one component is to be attached to another.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A laser solder bonding method for securing two components, comprising:
aligning a first component relative to a second component, said second component having a solder dam near a joint area;
placing solder on said second component between said solder dam and said first component; and
firing a laser at said solder to cause said solder to reflow, said solder making a solder joint to secure said first component to said second component.

2. A laser solder bonding method as recited in claim 1, further comprising:
placing a gas in said joint area prior to firing said laser.

3. A laser solder bonding method as recited in claim 2 wherein said first component comprises one of an electric, optical, and optoelectric component and said second component comprises a substrate.

4. A laser solder bonding method as recited in claim 3 further comprising:
positioning solder dams in at least two joint areas;
placing solder on said second component between each of said at least two solder dams and said first component; and
simultaneously firing two lasers to cause said solder to reflow in said at least two joint areas.

5. A laser solder bonding method as recited in claim 2 wherein said solder comprises one of a solder ball, a solder perform, and solder wire.

6. A laser solder bonding method as recited in claim 2 wherein said gas comprises at least one of an inert gas, a forming gas, and a formic gas.

7. A laser solder bonding method as recited in claim 3 further comprising:
using a gripper tool to align said first component to said substrate.

8. A laser solder bonding method as recited in claim 2 further comprising:
tacking said first component to said second component.

9. A component securely laser solder bonded to a substrate, made by the process, comprising:
aligning a component relative to a substrate, said substrate having a solder dam near a joint area;
placing solder in said joint area between said solder dam and said component; and
firing a laser at said solder to cause said solder to reflow, said solder making a solder joint to secure said component to said substrate.

10. A component securely laser solder bonded to a substrate, made by the process as recited in claim 9, further comprising:
placing at least one of an inert gas, a forming gas and a formic gas in said joint area prior to firing said laser.

11. A component securely laser solder bonded to a substrate, made by the process as recited in claim 10 wherein said component comprises one of an electric, optical, and optoelectric component.

12. A component securely laser solder bonded to a substrate, made by the process as recited in claim 10 further comprising:
positioning at least two solder dams in at least two joint areas;
placing solder in each of said at least two joint areas between each of said at least two solder dams and said component; and
simultaneously firing at least two lasers to cause said solder to reflow in said at least two joint areas.

13. A component securely laser solder bonded to a substrate, made by the process as recited in claim 10 wherein said solder comprises one of a solder ball, a solder perform, and solder wire.

14. A component securely laser solder bonded to a substrate, made by the process as recited in claim 10, wherein said inert gas comprises at least one of nitrogen, argon and helium.

15. A component securely laser solder bonded to a substrate, made by the process as recited in claim 10, further comprising:
using a gripper tool to align said component to said substrate.

16. A component securely laser solder bonded to a substrate, made by the process as recited in claim 10, further comprising:
tacking said component to said substrate.

17. A method for securing an optical component to a substrate, comprising:
using a gripper tool to align an optical component to a substrate, said substrate having at least a first and a second solder dam in at least two joint areas;
placing solder in said joint areas between said optical component and said solder dams;
evacuating oxygen from said joint areas;
simultaneously firing two lasers at said joint areas to reflow said solder to secure said optical component to said substrate.

18. A method for securing an optical component to a substrate as recited in claim 17 wherein evacuating oxygen from said joint areas comprises filling said joint areas with one of an inert gas, a forming gas and a formic gas.

19. A method for securing an optical component to a substrate as recited in claim 17 further comprising releasing said component from said gripper after reflow.

20. A method for securing an optical component to a substrate as recited in claim 17 further comprising tacking said optical component to said substrate.

21. A method, comprising:
aligning a first component relative to a second component using a gripper tool, said second component having at least a first and a second solder dam in at least two joint areas;
placing solder on said second component in said joint areas between said first and second solder dam;
evacuating oxygen from said joint areas; and
firing a laser at said solder to cause said solder to reflow, said solder making a solder joint to secure said first component to said second component.

22. The method as recited in claim 21, wherein evacuating oxygen from said joint areas comprises filling said joint areas with one of an inert gas, a forming gas and a formic gas.

23. The method as recited in claim 21 wherein said first component comprises an optical component and said second component comprises a substrate.
